(19) United States
(12) Patent Application Publication
(10) Pub. No.: US 2026/0192219 A1
(43) Pub. Date: Jul. 9, 2026

(54) A FILTRATION UNIT ASSEMBLY AND A FILTRATION SYSTEM

(71) Applicant: COUNCIL OF SCIENTIFIC & INDUSTRIAL RESEARCH, New Delhi (IN)

(72) Inventor: Anil Vamanrao Palghadmal, Pune (IN)

(73) Assignee: COUNCIL OF SCIENTIFIC & INDUSTRIAL RESEARCH, New Delhi (IN)

(21) Appl. No.: 19/134,516

(22) PCT Filed: Nov. 29, 2023
(86) PCT No.: PCT/IN2023/051111

§ 371 Date: May 30, 2025

(30) Foreign Application Priority Data
Dec. 2, 2022 (IN) 202211070213

(51) Int. Cl. B01D 33/067; B01D 33/11

(52) U.S. Cl. CPC B01D 33/067; B01D 33/11

(57) ABSTRACT

A filtration unit assembly (100) to separate solid and liquid mixtures is disclosed. A mixture of a solid and a liquid enters the top dish (110) through one or more inlets provided on the top dish. The received mixture for filtration then passes through a rotating drum (140) that is housed within a shell (150). The mixture of the solid and liquid enters the rotating drum and is exposed to a screw action by the rotary motion of the rotating drum (140). The resulting screw action separates the solid and the liquid as the liquid gets sucked towards the axis while the solids are pushed away from the axis of rotation of the rotating drum. The rotating drum (140) may be provided with perforations to aid in separation. A system for filtration that includes a filtration unit assembly (100) is also disclosed.

### FIELD OF INVENTION

The present invention relates to a novel filtration unit assembly. In particular, the present invention relates to a filtration unit assembly for continuous filtration system. More particularly, the present invention relates to a novel filtration unit assembly for a continuous filtration system for separation of solids from volatile or non-volatile liquids using a screw technique. The invention finds immense application in sectors such as but not limited to food, pharma, dyes, dye intermediates, agro and specialty chemicals. It shall help attain the 8^{th} and 9^{th} sustainable development goals of ‘decent work and economic growth’ and ‘industry, innovation and infrastructure’ respectively.

### BACKGROUND OF INVENTION AND DESCRIPTION OF PRIOR ART

Filtration is a mechanical method of removing solids from a suspension of liquid by passing the liquid through a porous media or screen while keeping the solids. Centrifugal filtration is resisted by the combined resistance of the porous filter and filter cake. Conventionally, filtration is driven by the pressure produced by the liquid medium.

Currently available filtration units used for handling volatile solvents operate in batch mode or in semiautomatic mode. There is a requirement of manpower and monitoring in the existing filtration units. System with fully automated separation of the solids from within the liquid medium is not available. Conventional techniques have the requirement of stopping to collect the accumulated solids from the filter.

The commercially available conventional filtration systems are rotary drum, centrifugal drum with basket, high speed centrifugal filtration systems and filter press etc. However, these all have limitations of handling volatile solvents, scale of fabrication, mode of operation and material of construction.

Therefore, there is a need in the art to develop a solution that provides fully automatic, continuous filtration of chemical processes on commercial as well as laboratory level, wherein there is no need of stopping to collect solids and liquids as the developed system provides continuous separation of solids and liquid at different ports. Thus, keeping in view the drawbacks of the hitherto reported prior art, the inventors of the present invention realized that there exists a dire need to provide a filtration system which is fully automated for continuous filtration of chemical processes on commercial as well as laboratory level, wherein there is no need of stopping to collect solids and liquid as it provides continuous separation of solids and liquid at different port owing to its interconnected components and flow of liquids and solids via screw technique which is not known in the literature till date, and wherein the developed filter system that may be interchangeably used to filter out solids of micro size as well as a large size depending on the requirements and applications. Furthermore, it is desirable to have a filter system which can be fabricated in any size, micro to large, having continuous mode of operation and which can employ any material of construction depending on end use i.e. considering compatibility of material to be separated.

### OBJECTIVES OF THE INVENTION

The main objective of the present invention to provide a filtration unit assembly for a continuous filtration system for separation of solids from volatile or non-volatile liquids.

Yet another object of the present invention to provide a filtration unit assembly for continuous filtration system for separation of solids from volatile or non-volatile liquids using screw technique.

Still another object of the present invention is to provide a system that can be used for different particle sizes after placing suitable filter media in the filtration assembly.

Yet another object is to separate the liquid and the solids on a close loop to recover solvents as well as to prevent solvent loss.

Still another objective of the present invention is to provide a method of continuous filtration for separation of solids from liquids.

### SUMMARY OF THE INVENTION

Aspects of the present invention relate generally to filtration systems and a novel filtration unit assembly. The present invention relates to a novel filtration unit assembly for continuous filtration system for separation of solids from liquids. More particularly, the present invention relates to a novel filtration unit assembly for continuous filtration system for separation of solids from volatile or non-volatile liquids using screw technique.

In an aspect, the filtration unit assembly consists of a top dish, with a rotating drum being nested within a shell that is abutted with the top dish at a first end of the shell and abutted with a bottom dish at a second end of the shell. The first rotating drum is actuated by an electric or a mechanical power source to rotate and thereby generate a screw effect in the process of rotation. A second rotating drum is positioned to receive fluid from the first rotating drum. A filter may be provided within the fixed drum to further separate out liquid and solid from a received mixture of the fluid and solid to be separated.

In a specific aspect, the present invention provides a filtration assembly unit comprising essential components in terms of first rotating drum (140) with perforations (for better filtration), second rotating drum (130) with pores, and filter (160) for additional effective filtration and separation of solids and liquids from mixture. The additional supporting components in the assembly are top dish (110), a shell (150) and a bottom dish (120). Such a system with interconnected components and flow of liquids and solids via screw technique is not known in the literature.

In another aspect, the shell (150) is provided with one or more flanges (152), that abut with flanges (112), (122) on the top dish (110) and the bottom dish (120) respectively.

In another aspect, the hole diameter of perforations in the first rotating drum (140) and pores in the second rotating drum (130) is in the range of 0.1 mm to 10 mm.

In another aspect, the second rotating drum (130) that receives the porous filter may be of any size, specifically customized to cater to micro for small quantities and for commercial purposes. The filter pore size is in the range of 20 micron to 500 micron.

In another aspect, the material of construction for the filter is selected from paper, cloth, polymer and metal. Preferably, material of construction for the filter is selected from fabric like polyester and cotton in cloth category; nylon, propylene and PTFE flexible sheets in polymer category; and stainless steel mesh in metal category.

In an aspect, the rotating drum (140) of Groove depth, thread thickness and angle the stepped cylindrical structures on the surface of the rotating drum may be varied and customized to have infinite number of variations depending on application. The rotating drum (140) encompasses stepped cylindrical structures on the surface with angle in the range of 0° to 15°.

In another aspect, the speed of rotation of the rotating drum (140) and (130) is in the range of 10 to 500 rpm.

In another aspect, the gap between the first rotating drum (140) and shell (150) is in the range of 0.2 mm to 1.0 mm.

In yet another aspect, the present invention provides a continuous filtration system consisting of filtration unit assembly (100), for separation of solids from volatile or non-volatile liquids using a screw technique. Further, the filtration unit assembly operates vertically for volatile liquids and horizontally for non-volatile liquids.

In yet another aspect, the present invention provides a method of continuous filtration system for separation of solids from liquids, wherein the mixture of solid and liquid enters from the inlet at top dish (110). As the mixture reaches the perforated rotating drum (140), liquid from the mixture gets sucked inside the drum and the solids are separated outwards because of the resulting screw action and conveyed to an outlet that may be provided in the bottom dish (120). Liquid may be collected from nozzles fitted at the bottom dish (120) thereby enabling separation of solids and the liquids continuously.

Various objects, features, aspects and advantages of the inventive subject matter will become more apparent from the following detailed description of preferred embodiments, along with the accompanying drawing figures in which like numerals represent like components.

### BRIEF DESCRIPTION OF THE ACCOMPANYING DRAWINGS

The accompanying drawings are included to provide a further understanding of the present invention, and are incorporated in and constitute a part of this specification. The drawings illustrate exemplary embodiments of the present invention and, together with the description, serve to explain the principles of the present invention. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

The nature and scope of the present invention will be better understood from the accompanying drawings, which are by way of illustration of a preferred embodiment and not by way of any sort of limitation. In the accompanying drawings: FIG. 1 is an illustration of the filtration unit assembly in accordance with an embodiment of the present invention.

FIG. 2 illustrates the fixed drum of the filtration unit assembly in accordance with an embodiment of the present invention.

FIG. 3 exemplifies the rotating drum of the filtration unit assembly in accordance with an embodiment of the present invention.

FIG. 4 represents the shell of the filtration unit assembly in accordance with an embodiment of the present invention.

FIG. 5 illustrates a diagram of the bottom dish of the filtration unit assembly in accordance with an embodiment of the present invention.

FIG. 6 represents the top dish of the filtration unit assembly in accordance with an embodiment of the present invention.

FIG. 7 illustrates an exploded view of the filtration unit assembly of FIG. 1 in accordance with an embodiment of the present invention.

The foregoing shall be more apparent from the following more detailed description of the invention.

### DETAILED DESCRIPTION OF THE INVENTION

In the following description, for the purposes of explanation, various specific details are set forth in order to provide a thorough understanding of embodiments of the present invention. It will be apparent, however, that embodiments of the present invention may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the invention. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Various methods described herein may be practiced by combining one or more machine-readable storage media containing the code according to the present invention with appropriate standard computer or mobile hardware, along with a computer application or Android or IOs application, to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In all the figures, like reference numerals represent like features. Further, when in the following it is referred to “top portion”, “left inside”, “right inside”, “upward”, “downward”, “above” or “below”, “front”, “rear” and similar terms, this is strictly referring to an orientation with reference to the apparatus, where the base of the apparatus is horizontal and is at the bottom portion of the figures and the portion facing the reader in the diagrams is the front of the apparatus. Further, the number of components shown are exemplary and not restrictive and it is within the scope of the invention to vary the shape and size of the apparatus as well as the number of its components, without departing from the principle of the present invention.

While describing a particular figure, certain features have been also referred to which are shown in some other figures. For the sake of convenience, the figure number is given for such features for understanding. Further, at the beginning only the structure of the apparatus is explained with reference to each figure. Thereafter, the functioning is explained separately and for that purpose the figures are again referred to highlighting on the functional part.

In an aspect, the filtration unit assembly consists of a top dish 110, with first rotating drum 140 nested within a shell 150 that is abutted with the top dish 110 at a first end and a bottom dish 120 at a second end. The rotating drum 140 is actuated by an electric or a mechanical power source to rotate and thereby generate a screw effect in the process of rotation. A second rotating drum 130 is positioned to receive fluid from the first rotating drum 140. A filter 160 may be provided within the rotating drum 130 to further separate out liquid and solid from a received mixture of the fluid and solid to be separated.

In an embodiment, both the rotating drums 140 and 130 are moving while operation as both are fixed with threads.

In an embodiment, a mixture of a solid and a liquid enters the top dish 110 through one or more inlets provided on the top dish. The received mixture for filtration then passes through the first rotating drum 140 that is housed within a shell 150. The mixture of the solid and liquid enters the rotating drum 140 and is exposed to a screw action by the rotary motion of the rotating drum 140. The resulting screw action separates the solid and the liquid as the liquid gets sucked towards the axis while the solids are pushed away from the axis of rotation of the rotating drum. The separation is further exemplified by the porous second rotating drum 130. The separated solids and liquid are collected in the bottom dish 120. The bottom dish 120 comprises one or more outlets to separate out the liquid and the solids. Nozzles may be provided at the outlets in the bottom dish 120 to separate out the liquid. The rotating drums 140 and 130 may be provided with perforations to aid in separation.

Referring now to FIG. 1 that is a diagram of the filtration assembly in accordance with an embodiment of the present invention. A mixture of a solid and a liquid enters the top dish 110 through one or more inlets provided on the top dish. The received mixture for filtration then passes through the first rotating drum 140 that is housed within a shell 150. The mixture of the solid and liquid enters the rotating drum 140 and is exposed to a screw action by the rotary motion of the rotating drum 140. The resulting screw action separates the solid and the liquid as the liquid gets sucked towards the axis while the solids are pushed away from the axis of rotation of the rotating drum 140. The separation is further exemplified by the porous second rotating drum 130. The separated solids and liquid are collected in the bottom dish 120. The bottom dish 120 comprises one or more outlets to separate out the liquid and the solids. Nozzles may be provided at the outlets in the bottom dish 120 to separate out the liquid. The rotating drums 140 and 130 may be provided with perforations to aid in separation.

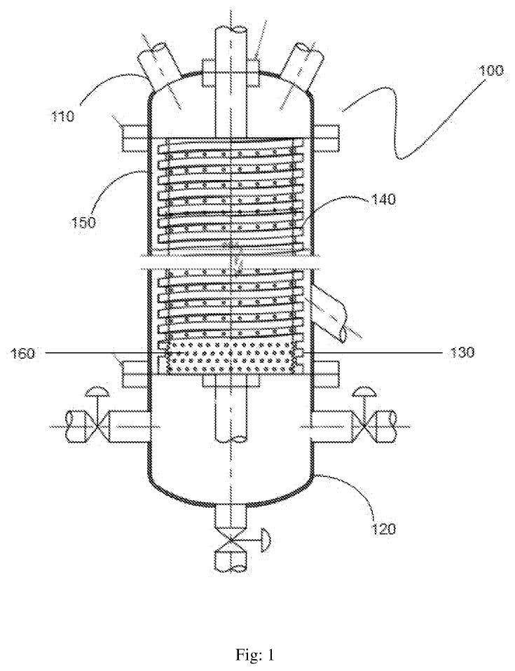

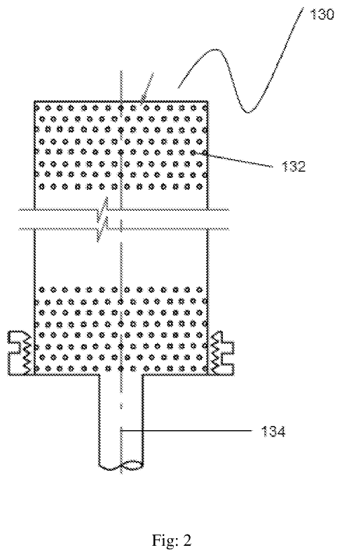

Referring now to FIG. 2 which is a diagram of the second rotating drum 130 of the filtration unit assembly 100 in accordance with an embodiment of the present invention, the rotating drum is hollow and may be configured to receive a filter. A plurality of pores may be provided on the rotating drum 130 to enable separation of the liquid from the solid. The rotating drum 130 may be rotated by manual or mechanical means.

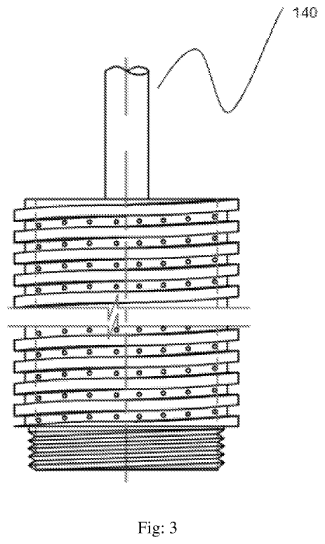

Referring to FIG. 3 which is a diagram of the first rotating drum 140 of the filtration unit assembly 100 in accordance with an embodiment of the present invention, the rotating drum 140 may be configured to be operated by a remotely controlled motor installed with the filtration system. The rotating drum 140 may be rotated by manual or mechanical means.

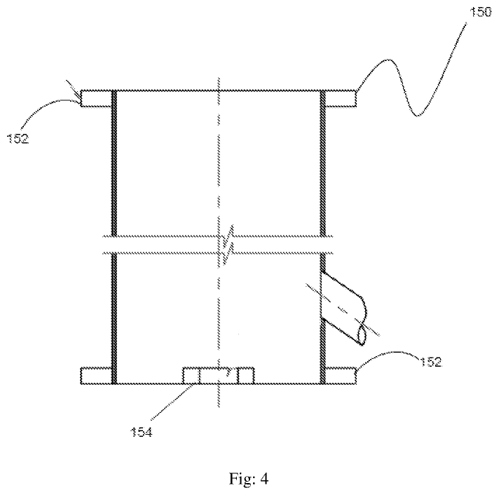

FIG. 4 is a diagram of a shell 150 that accommodates the rotating drum 140 of the filtration unit assembly 100 in accordance with an embodiment of the present invention. The Shell 150 may be provided with one or more flanges 152 that abut with flanges provided on the top dish and the bottom dish 112, 122 and fastened by a fastening means. The flange may be a stepped flange in an embodiment. A solvent proof gland 154 may be provided at the axial centre of the Shell 150 to prevent leakage of liquid when the liquid passes on to downwards through solid outlet nozzle because of the resultant screw action on the mixture. Depending on the application, size of filtration unit will be decided and the pitch of screw may vary accordingly. The pitch of the screw is kept at minimum of 1 mm.

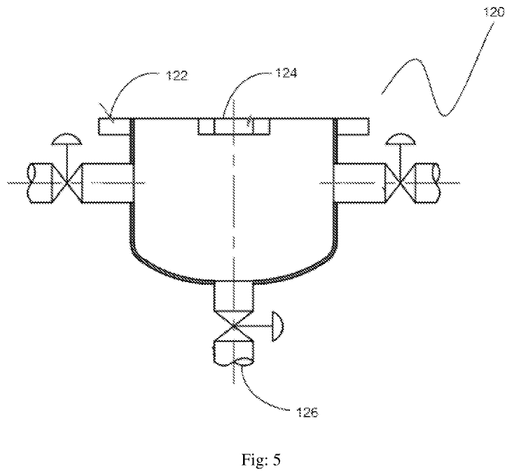

FIG. 5 is a diagram of the bottom dish 120 of the filtration unit assembly 100 in accordance with an embodiment of the present invention. A plurality of flanges 122 may be provided to enable abutment with the shell 150. The bottom dish 120 is configured to collect the separated liquid. A nozzle 126 may be provided to thereby enabling separation of solids and the liquids continuously.

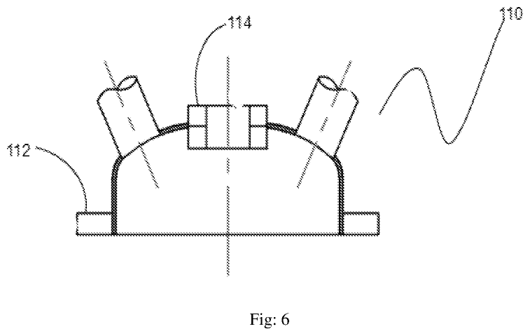

FIG. 6 is a diagram of the top dish 110 of the filtration unit assembly 100 in accordance with an embodiment of the present invention. The top dish 110 may comprise a leak proof gland 114 to prevent leakage of the separated liquid. One or more inlets may be provided to input the mixture of the solid and liquid that is to be separated. A single flange/plurality of flanges may be provided to enable abutment with the shell 150.

In an embodiment, the hole diameter of perforations provided in the rotating drum 140 may be of the range 0.1 mm to 10 mm.

A porous filter 160 may be placed on the outer surface of drum 130. Further along with porous filter media 160, drum 130 is fitted inside the drum 140. Drum 140 and 130 are fixed with the threads at the bottom of both drums. Hence it becomes a detachable arrangement and one can replace different filter media with simply removing and fitting drum 130 and 140.

In an embodiment, the hole diameter of the perforation provided in the second rotating drum 130 may be in the range of 0.1 mm to 10 mm.

In an embodiment, the first rotating drum 140 as illustrated in FIG. 3 may have a stepped cylindrical surface. The rotating drum 140 may be comprised of a plurality of pores on a stepped cylindrical surface. In an embodiment, the stepped cylindrical structure may be at an inclination to the axis. Multiple grooves may be provided on the surface of the rotating drum 140.

In an embodiment, the second rotating drum 130 receives the porous filter with size in the range of 20 micron to 500 micron, specifically customized to cater to micro for small quantities and for commercial purposes. Moreover, the material of construction for the filter is selected from paper, cloth, polymer and metal. Preferably, material of construction for the filter is selected from fabric like polyester and cotton in cloth category; nylon, propylene and PTFE flexible sheets in polymer category; and stainless steel mesh in metal category.

In an embodiment, the rotating drum 140 of Groove depth, thread thickness and angle the stepped cylindrical structures on the surface of the rotating drum may be varied and customized to have infinite number of variations depending on application. The rotating drum (140) has stepped cylindrical structures on the surface with angle in the range of 00 to 15°. Since, this type of filtration units can be fabricated for laboratory use in very small scale of operation as well as commercial scale, the range of parameters of the drum will vary accordingly.

In an exemplary embodiment, a Speed of rotation of the perforated rotating drum 140 or 130 may be in a range of 10 to 500 rpm.

In another embodiment, the gap between the first rotating drum (140) and shell (150) may be in a range of 0.2 mm to 1 mm. Preferably, the gap between the first rotating drum (140) and shell (150) is 0.5 mm.

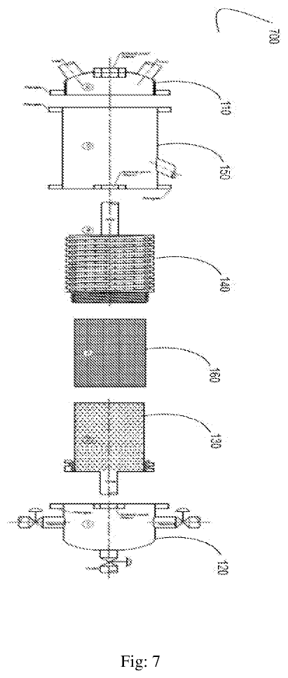

FIG. 7 is an exploded view 700 of the filtration unit assembly 100 of FIG. 1 in accordance with an embodiment of the present invention.

In another embodiment, the filtration unit assembly may be used vertically and horizontally, wherein, operate vertically for volatile compounds and horizontally for non-volatile compounds. In an embodiment, the mixture of solid and liquid enters from the inlet at top dish 110. As the mixture reaches the perforated rotating drum 140, liquid from the mixture gets sucked inside the drum and the solids are separated outwards because of the resulting screw action and conveyed to an outlet that may be provided in the bottom dish 120. Liquid may be collected from nozzles fitted at the bottom dish 120 thereby enabling separation of solids and the liquids continuously.

In embodiment, a filtration system can be fabricated, comprising the filtration unit assembly as discussed herein. The filtration system may be comprised and constructed in any material of construction to handle corrosive chemicals. The filtration system may be configured to handle wide ranges of flow rates. As continuous solid discharge is there, it gives fully automatic and robotic operation to the entire chemical process from start to end.

### EXAMPLES

The following examples are given by way of illustration only and therefore should not be construed to limit the scope of the present invention in any manner.

In an exemplary implementation of the present invention of the filtration system including the filtration assembly unit 100 disclosed in the present invention, saturated 25% (w/v), 5 L mixture of sodium bicarbonate and acetone was prepared to check functioning of filtration system and input into the filtration unit assembly. The rotating drum 140 (Screw motor) speed was set at 100 rpm using a variable frequency device. The rotating drum 140 attached with the motor is having screw arrangement on its surface and perforated drum 130 which is fitted inside drum 140 are fixed with bottom male female threads on both the drums. Hence it becomes a part and drum 130 has the same speed as of drum 140. Mixture was then charged with a special device at a flow rate 100 ml/min at room temperature. Vacuum of 550 mm hg was applied to the system. After achieving stable condition, outlet mass was collected in the bottom dish 120. Resulting flow rate of separated solid was 30 gm/min continuously and 65 ml of acetone collected in the mother liquor receiver. The continuous separation of the solids and maintenance of a continuous outlet flow rate is observed at the nozzles configured with the bottom dish.

In yet another exemplary implementation of the filtration system comprising the filtration unit assembly 100 as disclosed, solid liquid mixture from continuous flow stream containing 1:30 ratio of azelaic and solvent was charged with special device at flow rate 83.25 ml/min at room temperature to continuous filtration system. Screw motor speed was set at 100 rpm using a variable frequency device. Vacuum of 550 mmhg was applied to the system. After achieving stable condition, outlet mass was collected. Resulting flow rate of separated solid was 2.2 gm/min continuously and 77 ml of solvent collected in the mother liquor receiver.

The proposed system eliminates the requirement of stopping to collect solids and liquid. The proposed system enables continuous separation of solids and liquids at different ports provided within the filtration assembly. The present invention brings out novel continuous filtration using screw for fully automatic operation. One can replace filter media depending on the size of particles present in liquid.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

We claim:

1. A filtration unit assembly (100) comprising of:
a first rotating drum (140) with perforations;
a second rotating drum (130) with pores;
a filter (160); and
supporting components in the assembly comprising a top dish (110), a shell (150) and a bottom dish (120);
wherein the first rotating drum (140) with the screw is nested within a shell (150) that is abutted with the top dish (110) at the first end, and the bottom dish (120) at the second end, the second rotating drum (130) is positioned to receive liquid from the first rotating drum (140), and the filter (160) is provided within the rotating drum (130) to further separate out liquid and solid from a mixture.

2. The filtration unit assembly as claimed in claim 1, wherein the first rotating drum (140) and the second rotating drum (130) are actuated by an electric or a mechanical power source to rotate and thereby generate a screw effect in the process of rotation.

3. The filtration unit assembly as claimed in claim 1, wherein the shell (150) comprises one or more flanges (152), that abut with flanges (112), (122) on the top dish (110) and the bottom dish (120) respectively.

4. The filtration unit assembly as claimed in claim 1, wherein the hole diameter of perforations in the first rotating drum (140) and pores in the second rotating drum (130) is in the range of 0.1 mm to 10.0 mm and gap between the first rotating drum (140) and the shell (150) is in the range of 0.2 mm to 1.0 mm.

5. The filtration unit assembly as claimed in claim 1, wherein the rotating drum (140) has stepped cylindrical structures on surface with angle in the range of 0° to 15°.

6. The filtration unit assembly as claimed in claim 1, wherein the speed of rotation of the rotating drum (140) and (130) is in the range of 10 to 500 rpm.

7. The filtration unit assembly as claimed in claim 1, wherein the filter pore size is in the range of 20 micron to 500 micron.

8. The filtration unit assembly as claimed in claim 1, wherein a material for construction of the filter is selected from paper, cloth, polymer, metal and fabric such as polyester and cotton in cloth category; nylon, propylene and PTFE flexible sheets in polymer category;
and stainless steel mesh in metal category.

9. A continuous filtration system comprising of filtration unit assembly (100) as claimed in claim 1, for separation of solids from volatile or non-volatile liquids using a screw technique, wherein the filtration unit assembly operates vertically for volatile liquids and horizontally for non-volatile liquids.

10. A method of continuous filtration system for separation of solids from liquids employing the filtration assembly as claimed in claim 1, the said method comprising:
introducing the mixture of solid and liquid from the inlet at top dish (110); as the mixture reaches the perforated rotating drum (140), liquid from the mixture gets sucked inside the drum and the solids are separated outwards because of the resulting screw action and further conveyed to an outlet that is provided in the bottom dish (120); collecting the liquid from nozzles fitted at the bottom dish (120) thereby enabling separation of solids and the liquids continuously.
